(19) United States
(12) Patent Application Publication
(10) Pub. No.: US 2017/0310642 A1
(43) Pub. Date: Oct. 26, 2017

(54) BLACK CHANNEL COMMUNICATIONS APPARATUS AND METHOD

(71) Applicant: GE Intelligent Platforms, Inc., Charlottesville, VA (US)

(72) Inventors: Richard Joseph GLOSSER, Salem, VA (US); Fred Henry BOETTNER, Roanoke, VA (US); Robert Earl GRUBBS, Troutville, VA (US)

(21) Appl. No.: 15/510,005

(22) PCT Filed: Sep. 10, 2014
(86) PCT No.: PCT/US2014/054933

§ 371 Date: Mar. 9, 2017

(51) Int. Cl. H04L 29/06

(52) U.S. Cl. CPC H04L 63/04; H04L 63/123; H04L 69/22

(57) ABSTRACT

An apparatus and corresponding methods are provided for transmitting secure communications. The apparatus includes a transmitter and a receiver having an interface, a processor, and a memory. The processor instances a secure transmission function, links program data to the secure transmission function, and determines a transmission channel that does not have to satisfy security requirements to transmit the program data and the secure transmission functions. The transmitter transmits the program data and the secure transmission function across the transmission channel to the receiver, where the receiver processor instances a secure reception function corresponding to the secure transmission function and specifies a connection between a communication receiver path. The processor attaches a data output to the secure reception function corresponding to the data programmed into the transmitter, and executes and compares the reception function to the transmission function to determine if the linked data should be sent to the receiver interface.

### TECHNICAL FIELD

The subject matter disclosed herein generally relates to a computer-based communications network for secure data transmission.

### BACKGROUND

A variety of computer-based approaches have been used in environments requiring secure data transmissions. The transmitted data is used, for example, to ensure proper and safe operation of control systems in industrial environments such as processing or manufacturing plants. In such environments, it is of key importance to ensure the communication, oftentimes containing a form of safety data, has successfully been received by the receiver. Additionally, in such environments, it is equally important to confirm the received communication accurately corresponds to the transmitted communication. Any number of additional threats, such as data repetition, deletion, insertion, resequencing, corruption, and/or delay may occur during the transmission process. As such, these communications channels must conform to exacting standards to be used in these environments to reduce or avoid the possibility of system failure.

Generic communication channels cannot be certified to handle safety data. Without a certified communication channel between suitable controllers, application realizations would not be possible. In current communication systems, which do employ safety integrity measures, these systems incorporate the security features at the file transmission stage. As such, current systems rely on the secure communications features being “superimposed” on a standard communication in the data transmission network. By using these “superimposed” safety features, current systems rely on networking equipment that passes necessary safety certifications which is oftentimes expensive, and oftentimes limit the number of operational transmissions being communicated at a given time. Prior attempts to overcome these drawbacks also include the use of proprietary communication systems and closed serial networks. This specific and/or specialized communication equipment commonly has limitations on system size and complexity.

The above-mentioned problems have resulted in some user dissatisfaction with previous approaches.

### BRIEF DESCRIPTION

The approaches described herein provide systems and related methods that allow for secure communication (e.g., communications conforming to “Black Channel” standards) transmissions between transmitters and receivers. By using the system described herein, data from transmitters are transmitted across generic data transmission networks to a target receiver while maintaining required security protocols. The system described herein allows for the security of the data transmission to be checked on both the transmission and the reception ends, thus allowing the data transmission to meet Black Channel criteria.

Accordingly, multiple data transmitters may be employed in a single application to transmit data across a number of different communication paths as desired. As a result, the system may result in higher data integrity solutions and reduced system risks. Any number of distributed data communications may be envisioned on an as-needed basis.

The approaches described herein enable applications to incorporate lower cost networking equipment that does not have to meet stringent safety certification requirements. Additionally, by eliminating the requirement for secure communications channels, any limitations on the system due to complexity are effectively eliminated.

In some examples, a method is provided where, at a data originator, a secure transmission function is instanced, program data is linked to one or more inputs of the secure transmission function, and a transmission approach to transmit the linked program data and the one or more inputs of the secure transmission function is determined. This transmission approach does not have to satisfy security requirements. Next, the method translates the one or more inputs into a data structure and stores the data structure in a memory. A security signature or wrapper is then computed, and a transmission packet containing the data structure and the security signature is created. The transmission packet may then be transmitted over the determined transmission approach.

In some examples, the method provides the steps of, at a data receiver, instancing a secure reception function corresponding to the secure transmission function, specifying a connection between an available communication receiver path and the instanced secure reception function, and attaching a received data input corresponding to the data programmed into the transmission packet to the secure reception function. The method may further include passing received data to the secure reception function, executing the reception function and confirming the security of the data by the security signature. When the security of the data is confirmed, the programmed system writes the received data into the attached data output. Conversely, when the security of the data is not present, the lack of security is indicated at the programmed system. Additionally, the method may be repeated at predetermined intervals.

In some approaches, the transmitted transmission is directed into a plurality of channels having no security requirements. The plurality of channels may comprise an Ethernet-based communications path, a serial communication path, and/or a radio data link. In other approaches, computing the security signature may include computing a data originator unique identifying value used to describe the data structure. Additionally, the data originator unique identifying value may include computing a first value that identifies the program data and a second value that identifies the data structure.

In many of these embodiments, a transmitter apparatus and corresponding methods includes an interface with an input and an output, a memory, and a processor. In these approaches and at predefined time intervals, the processor is configured to instance at least one secure transmission function and link program data to at least one input of the secure transmission function. The processor is additionally configured to determine a transmission channel to transmit the linked program data and the inputs of the secure transmission functions that does not have to satisfy security requirements and translate the one or more inputs into a data structure. The transmitter apparatus then is configured to store the data structure in the memory, compute a security signature, and create a transmission packet comprising the data structure and the security signature.

In some approaches, the secure transmission function includes an executable command from a user system. In some approaches, the processor is also configured to transmit the transmission packet over the determined transmission channel which does not have to satisfy particular security requirements. Further, in some examples, the processor transmits the transmission to a plurality of channels having no security requirements.

In many of these embodiments, a data receiver apparatus is also provided that similarly includes an interface with an input and output, a memory, and a processor. The processor is coupled to the interface and the memory and is configured to, at predetermined time intervals, instance a secure reception function corresponding to the secure transmission function at the transmitter apparatus and specify a connection or connections between an available communication receiver path and the instanced secure reception function. The processor is also configured to attach a data input to the secure reception function corresponding to the data programmed into the associated transmitter.

In further examples, the processor of the data receiver apparatus is configured to pass the received data to the secure reception function and execute the reception function. At this point, the security of the data is confirmed by the data wrapper. Upon confirming the security of the data, the data receiver apparatus writes the received data into an attached data output to be used by the corresponding system or apparatus. Conversely, when the security of the data is not present, the data receiver apparatus is configured to indicate the lack of security. This indication may occur in the form of an alarm, alert, or message.

### BRIEF DESCRIPTION OF THE DRAWINGS

For a more complete understanding of the disclosure, reference should be made to the following detailed description and accompanying drawings wherein:

FIG. 1 comprises a block diagram illustrating an exemplary communication system according to various embodiments of the present invention;

FIG. 2 comprises an operational flow chart illustrating a method for creating a secure transmission packet according to various embodiments of the present invention;

FIG. 3 comprises an operational flow chart illustrating a method for receiving a secure transmission packet according to various embodiments of the present invention;

FIG. 4 comprises a call flow diagram illustrating an exemplary communication system according to various embodiments of the present invention;

FIG. 5 comprises an exemplary block diagram illustrating a system for transmitting a secured communication according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Approaches are provided that overcome the need for dedicated secure transmission devices which may be costly and may provide limited system integration. In one aspect, the black channel communications allows for secure communications to be transmitted using conventional communication channels or networks such as an Ethernet-based communications network, serial based communications network, radio-based communications network, or any other network known by persons having skill in the relevant art. By allowing the desired communication to have security protocols appended thereto prior to transmitting the communication, any number of communications channels may be simultaneously employed to transmit all or part of a communication, thus providing additional efficiencies to users.

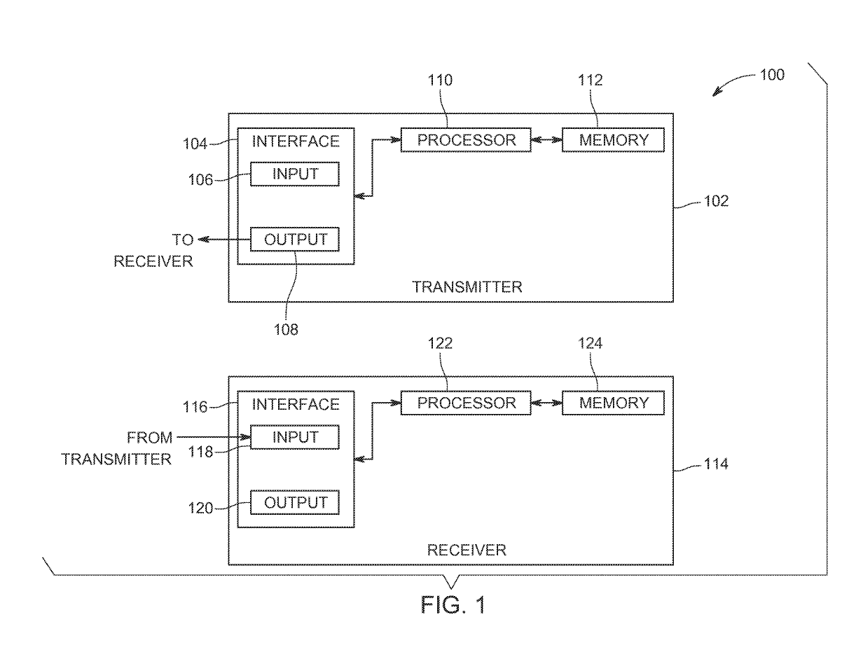

Referring now to FIG. 1, one example of a communication system 100 is described. The communication system 100 includes a transmitter 102 which includes an interface 104 having an input 106 and an output 108, a processor 110, and a memory 112. The communication system 100 also includes a receiver 114 which similarly includes an interface 116 having an input 118, an output 120, a processor 122, and a memory 124.

The transmitter 102 is any combination of hardware devices and/or software selectively chosen to generate and transmit communications. The receiver 114 is a combination of hardware devices selectively chosen to receive and generate communications. The interface 104 is a computer based program configured to accept a command at the input 106 and transmit the generated communication at the output 108. Thus, the function of the interface 104 is to allow the transmitter 102 to communicate with a user and the receiver 114. The interface 116 is a computer based program configured to accept a transmitted input at the input 118 and transmit an output 120 to a second system (not shown). Thus, the function of the interface 116 is to allow the receiver 114 to communicate with the transmitter 102 and a secondary system.

The processor 110 of the transmitter 102 and the processor 122 of the receiver 114 may be any type of computing component capable of saving data to the memory 112 and 124 of the transmitter 102, and of the receiver 114, respectively. The memory 112 and 124 may be any type of device capable of storing data thereto.

It will be appreciated that the various components described herein may be implemented using a general purpose processing device executing computer instructions stored in memory.

The transmitter 102 communicates with the receiver 114 through interface 104 and provides the receiver 114 with commands received from input 106. These commands may come from a user or a control system, as desired. It is understood that in some approaches, a separate computing device may be configured to receive and analyze an input to send to processor 110.

The processor 110 communicates with interface 104 to process the input and apply the required security features to the communication and transmits the communication to the memory 112. The processor 110 additionally transmits the communication stored in the memory 112 to the output 108 to be sent to the receiver 114.

The processor 122 communicates with interface 116 to process the transmitted input and extract the security features and the communication and transmits the communication to the memory 124. The processor 110 additionally transmits the communication stored in the memory 124 to the output 120 to be sent to the external system.

In operation, at predetermined time intervals, the processor 110 instances at least one secure transmission function having inputs. For example, the processor 110 may instance a sequence function which ensures the communication is received in proper order. By “instance” and as used herein it is meant data is created for inclusion in the secure data structure that conveys the order of creation of the secure data structure. Alternatively, the processor 110 may instance a connection ID number which ensures the received communication corresponds to the transmitted communication from the transmitter 102. Further still, the processor may instance a signature function which is specific to contents of a particular communication.

The processor 110 then links program data received at the input 106 to an input of the secure transmission function. In other words, the program data are appended to the secure transmission function. The processor then is configured to determine a transmission channel to transmit the linked program data and the secure transmission function. This transmission channel may be, for example, an Ethernet-based communications network, serial-based communications network, radio-based communications network, or any other commonly-used communications network which do not require satisfaction of security and/or safety requirements. It is understood that the processor 110 may use any number of communication channels as desired.

The processor 110 is further configured to translate the inputs of the secure transmission function and the linked program data into a data structure which is stored in memory 112. Any type of commonly used data structure may be incorporated capable of storing security functions and program data.

Even further still, the processor 110 is configured to compute a security signature or wrapper for the data structure to provide an additional level of security. Processor 110 then creates a transmission packet having the data structure and the security signature, and instructs output 108 to transmit the transmission packet. By “security signature” and as used herein, it is meant a numeric method applied to data that confirms the received data is identical to the transmitted data

Turning to the receiver 114, at predetermined time intervals, the processor 122 instances at least one secure reception function corresponding to the secure transmission function described above. These functions may include the sequence function ensuring the communication is received in proper order, the connection ID number ensuring the received communication corresponds to the transmitted communication from the transmitter 102, and a signature function specific to contents of the particular received communication.

The processor 122 then specifies a connection between an available communication receiver path at input 118 and the instanced secure reception function. The processor 122 then attaches a data output to the secure reception function which corresponds to data programmed into transmitter 102. Processor 122 stores this data to memory 124, and passes this data to the secure reception function to execute the reception function. At this point, the security of the data is confirmed by matching the contents of the secure reception function to contents of the secure transmission function.

When the security of the data is confirmed, the processor 110 stores the contents to the memory 124, thus allowing the data to be used at output 120 as desired. Any type of commonly used data structure may be incorporated capable of storing security functions and program data. The output 120 may be connected to any type of system or apparatus capable of receiving and executing commands.

When the security of the data is not confirmed, the processor 110 sends an alert to the output 120 indicating a lack of security. A user may then further explore the system 100 to determine the cause of the alert.

In some examples, the program data received at input 106 includes executable commands from a user system. These commands may be automatically generated in response to the system indicating the presence of a particular condition, for example an alarm condition. The executable command is thus transmitted from transmitter 102 to receiver 114 and used at output 120 to control a secondary system. Examples of commands include actuation of a valve, removing power from a circuit, or any other process control command.

In other examples, the processor 110 transmits a portion or all of the transmission into any number of communications channels having no security requirements.

So configured, the system 100 allows the transmission of secure data irrespective of the selected communications channel. The processor 110 may be programmed to automatically select a communications channel, or alternatively, the channel may be selectable by a user.

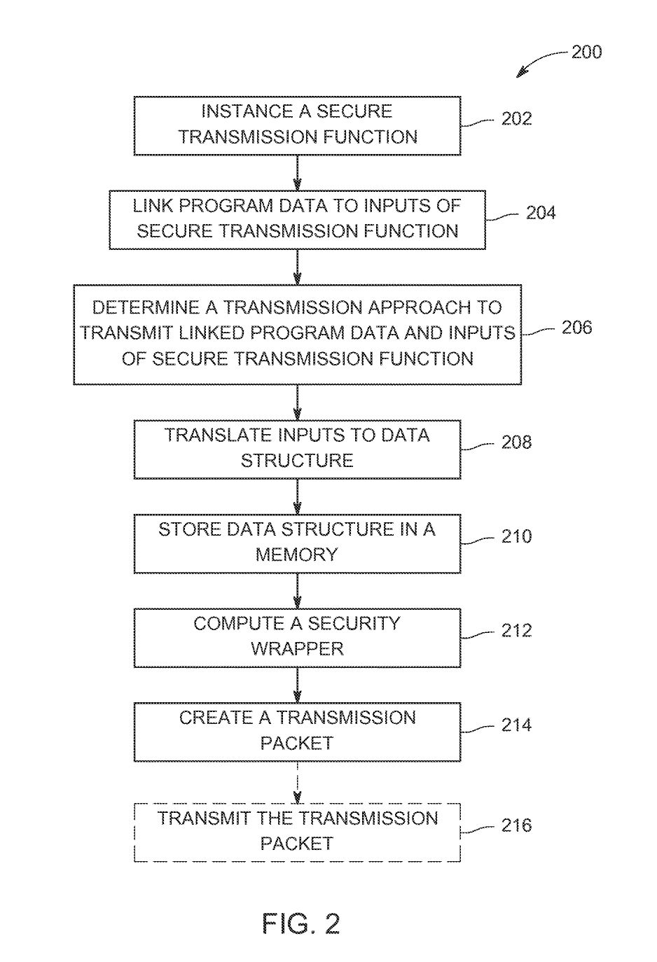

Referring now to FIG. 2, one example of a method 200 for creating a secure transmission packet is described. The method 200 occurs at a data originator and in an application programming environment. By “application programming environment” and as used herein it is meant an interactive computer program which captures actions to be performed by a programmable controller and conveys those actions to the controller where the transmit and/or receive functions occur. First, at step 202, a secure transmission function is instanced. Next, at step 204, program data is linked to inputs of the secure transmission function.

At step 206, a transmission approach is determined to transmit the linked program data and inputs of the secure transmission function. At step 208, the inputs are translated to a data structure. Next, at step 210, the data structure is stored to a memory. At step 212, a security signature is computed. At step 214, a transmission packet is created containing the data structure and the security signature, and at step 216, the transmission packet is transmitted.

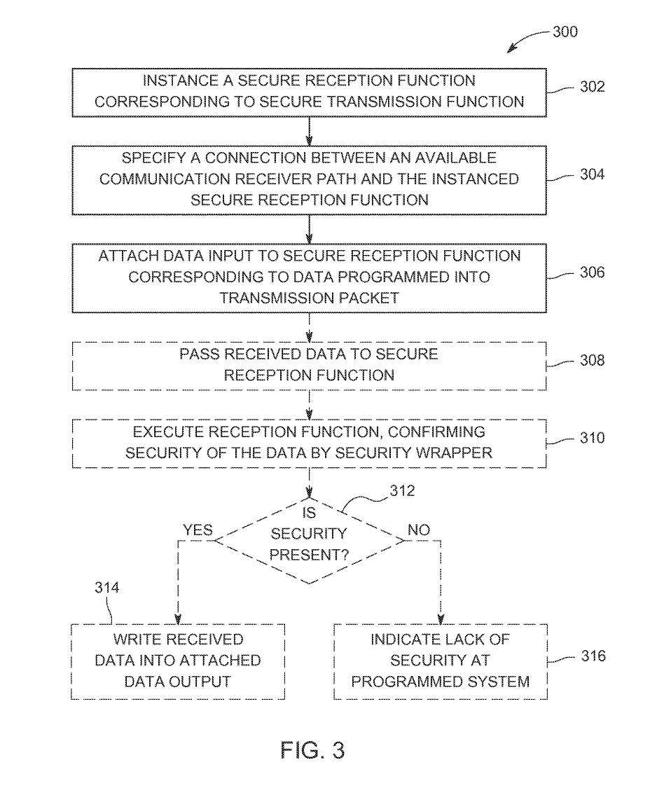

Referring now to FIG. 3, one example of a method 300 for receiving a secure transmission packet is described. The method 300 occurs at a data receiver and in the application programming environment. First, at step 302, a secure reception function is instanced that corresponds to the secure transmission function. Next, at step 304, a connection between an available communication receiver path and the instanced secure reception function is specified.

At step 306, data input that corresponds to data programmed into the transmission packet is attached to the secure reception function. At step 308, the received data is passed to the secure reception function.

At step 310 the secure reception function is executed to confirm the security of the data by the security signature. At step 312 the method 300 determines whether the security is confirmed. If the security is confirmed, at step 314, the received data is written to an attached data output. If the security is not confirmed, at step 316, the lack of security is indicated at a programmed system.

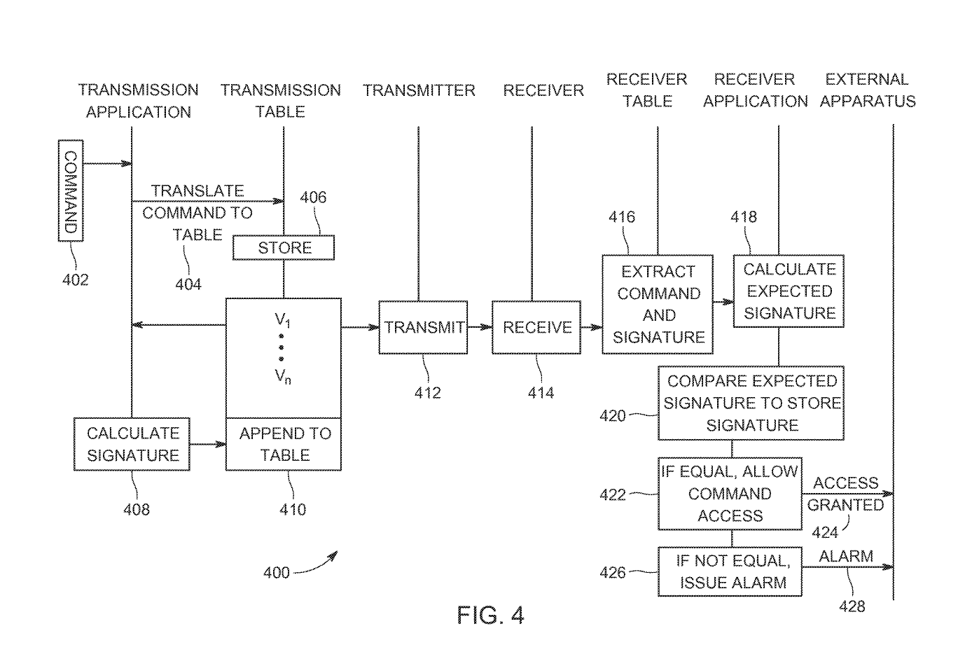

Referring now to FIG. 4, a call flow diagram illustrating an exemplary communications system 400 is provided. The communication system 400 sends a command 402 to a transmission application, which performs the action of translating the command to a table 404. A transmission table then stores the command 406 and the transmission application calculates a signature 408 based on the contents of the table. The calculated signature is then appended to the transmission table 410. A transmitter then transmits 412 the transmission table, and a receiver receives 414 the table. A receiver table extracts the command and signature 416. A receiver application then calculates an expected signature 418 and compares the expected signature to the stored signature 420. If the expected signature is equivalent to the stored signature 422, access to the command is granted 424 at an external apparatus. Conversely, if the expected signature is not equivalent to the stored signature 426, access is denied and an alarm 428 is sent to the external apparatus.

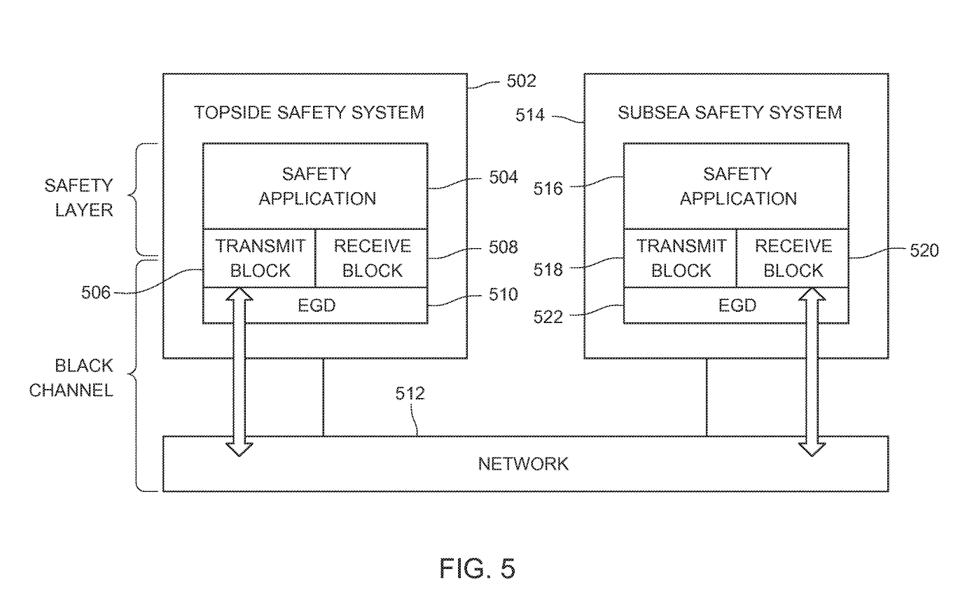

Referring now to FIG. 5, a block diagram illustrating a system 500 for transmitting a secure communication is provided. The system 500 includes a topside safety system 502 having a safety application 504, a transmit block 506, a receive block 508, and an Ethernet global data (EGD) protocol network stack 510. The system 500 further includes a network 512 and a subsea safety system 514 having a safety application 516, a transmit block 518, a receive block 520, and an EGD protocol network stack 522.

The topside safety system 502 may be any system used to monitor the status of other devices at remote locations. As an example, the subsea safety system 514 is provided to monitor the operation of a subsea system such as an oil extraction system. Safety application 504 and 516 may be any commonly known applications capable of displaying, receiving, and transmitting information pertaining to safety of implemented devices. It will be appreciated that the system of FIG. 5 is one example of a system that can utilize the present approaches and that other applications are possible.

Transmit block 506 and 518 are configured to transmit data across network 512 as needed, and similarly, receive block 508 and 520 are configured to receive data transmitted across the network 512 as required. The EGD protocol network stack 510, 522 are a protocol used to transfer data on the desired network. It is understood that any known protocol may be used to transfer data across the network, and the EGD protocol network stack 510, 522 protocol is merely provided as an illustrative example.

In operation, subsea safety system 514 may transmit a signal using transmit block 518 using EGD protocol network stack 522 through network 512. The signal arrives at receive block 508 via EGD protocol network stack 510. The user may then use safety application 504 to generate commands from the topside safety system 502. These commands are transmitted via transmit block 506 with EGD protocol network stack 510, network 512, and EGD protocol network stack 522. As illustrated, secure communication features (in this case Black Channel) are generated at the topside safety system 502 side as opposed to across the network 512. The receive block 520 of the subsea safety system 514 then receives the signal, and safety application 516 is configured to execute the command corresponding to the signal sent by the safety application 504 of the topside safety system 502. Secure communication features are extracted and compared to the generated secure communication features at the subsea safety system 514. So configured, the network 512 and EGD protocol network stack 510, 522 do not need any type of security information appended thereto to transmit messages between safety systems. This example depicts a cause and effect relationship, but it is understood that in some examples,

It is understood that in some forms, the system 500 does not require the subsea safety system 514 to send an initial command to the topside safety system 502 before the topside safety system 502 is used to generate a command. For example, conditions at the topside safety system 502 may necessitate sending a command to the subsea safety system 514 without any type of prompting therefrom.

It will be appreciated by those skilled in the art that modifications to the foregoing embodiments may be made in various aspects. Other variations clearly would also work, and are within the scope and spirit of the disclosure. Embodiments of the present invention are set forth with particularity in the appended claims. It is deemed that the spirit and scope of that disclosure encompasses such modifications and alterations to the embodiments herein as would be apparent to one of ordinary skill in the art and familiar with the teachings of the present application.

1. A method, comprising:
at a data originator and in an application programming environment:
instancing a secure transmission function;
linking program data to one or more inputs of the secure transmission function;
determining a transmission approach to transmit the linked program data and the one or more inputs of the secure transmission function, wherein the transmission approach does not have to satisfy security requirements;
translating the one or more inputs into a data structure;
storing the data structure in a memory;
computing a security signature; and
creating a transmission packet comprising the data structure and the security signature.

2. The method of claim 1, further comprising:
transmitting the transmission packet over the determined transmission approach.

3. The method of claim 2, further comprising:
at a data receiver and in the application programming environment:
instancing a secure reception function corresponding to the secure transmission function;
specifying a connection between an available communication receiver path and the instanced secure reception function; and
attaching a received data input corresponding to the data programmed into the transmission packet to the secure reception function.

4. The method of claim 3, further comprising:
at a programmed system:
passing received data to the secure reception function; and
executing the secure reception function, wherein security of the data is confirmed by the security signature;
wherein when the security of the data is confirmed, the programmed system writes the received data into an attached data output, and wherein when the security of the data is not present, indicating a lack of security at the programmed system.

5. The method of claim 2, wherein the method is repeated at predetermined intervals.

6. The method of claim 4, wherein the method is repeated at predetermined intervals.

7. The method of claim 2, wherein the transmitted transmission is directed into a plurality of channels having no security requirements.

8. The method of claim 7, wherein the plurality of channels comprise an Ethernet-based communications path, a serial communication path, and a radio data link.

9. The method of claim 1, wherein computing the security signature comprises computing a data originator unique identifying value used to describe the data structure.

10. The method of claim 9, wherein computing the data originator unique identifying value comprises computing a first value that identifies the program data and a second value that identifies the data structure.

11. A transmitter apparatus, comprising;
an interface with an input and an output;
a memory; and
a processor coupled to the interface and the memory, the processor configured to, at a predefined time interval, instance one or more secure transmission functions, link program data to one or more inputs of the secure transmission functions, determine a transmission channel to transmit the linked program data and the one or more inputs of the secure transmission functions, translate the one or more inputs into a data structure, store the data structure in a memory, compute a security signature, and create a transmission packet comprising the data structure and the security signature.

12. The transmitter apparatus of claim 11, wherein the processor is configured to transmit the transmission packet over the determined transmission channel via the output, wherein the determined transmission approach does not have to satisfy security requirements.

13. The transmitter apparatus of claim 11, wherein the program data comprises an executable command from a user system.

14. The transmitter apparatus of claim 11, wherein the processor transmits the transmission into a plurality of channels having no security requirements.

15. A data receiver apparatus, comprising;
an interface with an input and an output;
a memory; and
a processor coupled to the interface and the memory, the processor configured to, at a predefined time interval, instance a secure reception function corresponding to a secure transmission function, specify a connection between an available communication receiver path and the instanced secure reception function, and attach a data output to the secure reception function corresponding to data programmed into an associated transmitter.

16. The data receiver apparatus of claim 15, wherein the processor is further configured to pass received data to the secure reception function and execute the secure reception function, wherein security of the data is confirmed by the processor, wherein when the security of the data is confirmed, the data receiver apparatus writes the received data into the memory to be transmitted by the output of the interface, and wherein when the security of the data is not present, the data receiver apparatus is configured to indicate the lack of security at the output of the interface.

17. The data receiver apparatus of claim 16, wherein when the security of the data is present, the processor is configured to allow an apparatus to use the received data written to the data output.

18. The data receiver apparatus of claim 16, wherein the processor is further configured to issue an alert when a lack of security is determined.
